(19) United States
(12) Patent Application Publication
(10) Pub. No.: US 2008/0304452 A1
(43) Pub. Date: Dec. 11, 2008

(54) Method for a mobile phone to automatically adapt to different frequency bands

(75) Inventor: Johann Solvsteen, Horsens (DK)

Correspondence Address: ROBERT C. SCHLUER, 45 GROTON ROAD, SHIRLEY, MA, 01464, US

(73) Assignee: POLYCOM, INC

(21) Appl. No.: 11/811,380

(22) Filed: Jun. 8, 2007

(51) Int. Cl. H04Q 7/00

(52) U.S. Cl. 370/331

(57) ABSTRACT

A wide area communication network includes a first and second local wireless communication network, each local network operating in a different frequency band. A mobile phone previously configured to operate in the frequency band of the first local wireless communication network is transported to the second local wireless communication network and after powered runs a reconfiguration routine to operate in the frequency band of the second local wireless communication network. The reconfiguration routine includes scanning the wireless medium for a signal that includes wireless LAN identification information and after receiving such a signal comparing this identification information to identification information stored in the mobile phone. If the comparison results in a match, the mobile phone can successfully associate with the second local wireless communication network.

### FIELD OF THE INVENTION

My invention relates generally to the area of mobile communications devices that operate within a wireless local area network environment and specifically to a mobile communications device that automatically adapts to the different frequency bands and channels used by wireless local area networks in different regions of the world.

### BACKGROUND OF THE INVENTION

Individual state governmental and international agencies in different geographic areas of the world regulate and allocate particular frequency bands to be used for certain types of wireless communication networks. In Europe, the European Conference of Postal and Telecommunications Administrations (CEPT) allocates particular frequency bands to be used for short range, unlicensed wireless communication networks otherwise known as a WLAN, and in the United States, the Federal Communications Commission (FCC) allocates particular frequency bands to be used for similar WLANs. These WLANs can, for instance, operate according to particular standards that have been adopted for use in various parts of the world. One standard that has been adopted for use in wireless communications devices is the ETSI EN 300 175 series of standards which is commonly known as the DECT standard. The DECT standard has been adopted by all of the European countries and wireless devices operating within a DECT system have been allocated two frequency bands, namely; the frequencies from 1,880 MHz to 1,980 MHz and the frequencies from 1,980 MHz to 2,010 MHz. The DECT standard has also been adopted by the United States which has allocated two frequency bands for use by wireless devices operating according to this standard, namely; the frequencies from 902 MHz to 928 MHz and the frequencies from 2,400 to 2,483.5 MHz.

International organizations employing DECT based systems in both Europe and in the United States as their internal communication network find it convenient to have their employees transport their DECT capable mobile phones from offices in Europe to offices in the United States. Unfortunately, a mobile phone configured to operate in the European frequency bands will not operate in the frequency bands allocated for DECT networks in the United States. The typical solution to this problem is to carry several mobile phones each of which is capable of operating in a particular frequency band or to re-configure a mobile phone transported from Europe to the United Sates and vise-versa. Reconfiguring a mobile phone to operate in the frequency band of the local environment is not a straight forward process and it typically performed by a network administrator at the local site or by a technician in a factory. As this is the case, the mobile phone is usually not available to the user for some period of time. Further, when the employee travels back to Europe with the mobile phone, the phone has to again be reconfigured to operate in the frequency bands allocated in Europe. Carrying multiple mobile phones or the continual reconfiguration of a mobile phone so as to be operable in the locally allocated frequency bands is at best an inconvenience and at worst disruptive to the ability of the employee to communicate when traveling.

Therefore, it would be advantageous if a wireless communications device, such as a mobile phone, could be easily and automatically reconfigured when the user traveled from one location served by a WLAN employing one set of allocated frequency bands to another location served by another WLAN employing a different set of allocated frequency bands. Further, it would be advantageous if when a mobile phone was turned on and does not detect that there is an available frequency at which to operate, it automatically either prompts the user to select a registration function or runs an unprompted registration routine that once complete, identifies the locally allocated frequency bands and registers the mobile phone on the WLAN.

### SUMMARY OF THE INVENTION

In a preferred embodiment of my invention, a wireless communications device is preconfigured to operate within a first WLAN in a first frequency band; when the wireless communications device is powered on in a second WLAN operating in a second frequency band it automatically starts to scan the medium at preconfigured frequencies to receive a message from a device operating on the second WLAN containing a set of access information associated with this WLAN; the wireless communications device receives a message transmitted by the WLAN device on a particular frequency and detects in the message the set of access information associated with the second WLAN; the wireless communications device compares the detected set of access information associated with the second WLAN to be the same as a set of access information in the wireless communications device memory; and the wireless communications device transmits a message to the WLAN device that contains unique identification information using the same frequency as the receive message.

### BRIEF DESCRIPTION OF THE DRAWINGS

FIG. 1 is a high level diagram of a communications network including a WAN and two WLANs.

FIG. 2 is a high level block diagram showing the functional elements of a WLAN.

FIG. 3 is a high level functional block diagram of a PP that implements my invention.

FIG. 4 is a high level functional block diagram of an FP that supports the operation of my invention.

FIG. 5 shows an RFPI message in relation to a MAC frame format.

FIG. 6a is a logical flow diagram of the preferred operation of my invention.

FIG. 6b is a continuation of FIG. 6a.

### DETAILED DESCRIPTION OF THE INVENTION

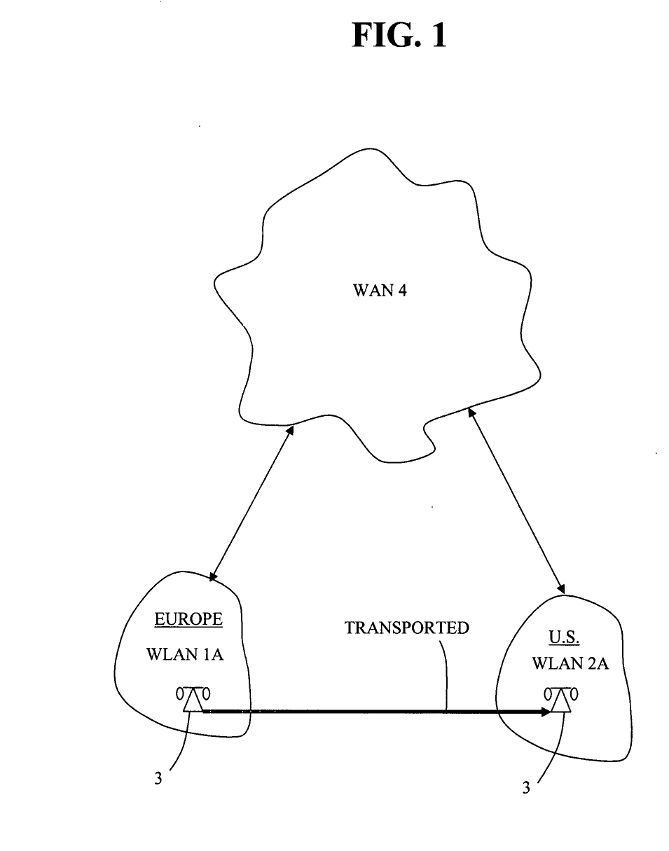

The public switched telephone network (PSTN) is one type of WAN composed of the world's public circuit-switched telephone networks and the Internet is another type of WAN composed of the world's packet-switched networks. Local area networks (LANs) that supports the transmission of voice, data, or some other information are typically connected to a wide area network (WAN) so that communication devices on one LAN, such as phones and computers can transmit and receive information to and from devices located on another LAN. LANs employing many different standards based and non-standards based technologies can be connected to a WAN through a network device typically referred to as a gateway or a PBX or both depending upon the information being transmitted over the LAN. A wireless LAN (WLAN) can be configured to support wireless communication devices such as a mobile phone, a PDA or some other form of mobile voice or data communications device. FIG. 1 is a high level diagram showing the relationship between a WAN 4 and two wireless LANs 1a and 2a.

A number of different short-range wireless communication technologies, such as DECT and WiFi, have been accepted as standards by international organizations and they are prevalent in wireless LAN environments. Both the DECT and WiFi standards operate in different frequency bands depending upon the geographic location of the WLAN. So for instance, WLANs supporting wireless communication devices that operate according to the DECT standard are allocated the 1880-1900 MHz frequency band in Europe and the 1920-1930 frequency band in the U.S. An organization with multiple sites in both Europe and the United States, for example, may maintain one or more WLANs at each site, each of which may operate at a particular frequency or frequencies within the band allocated for that geographic region.

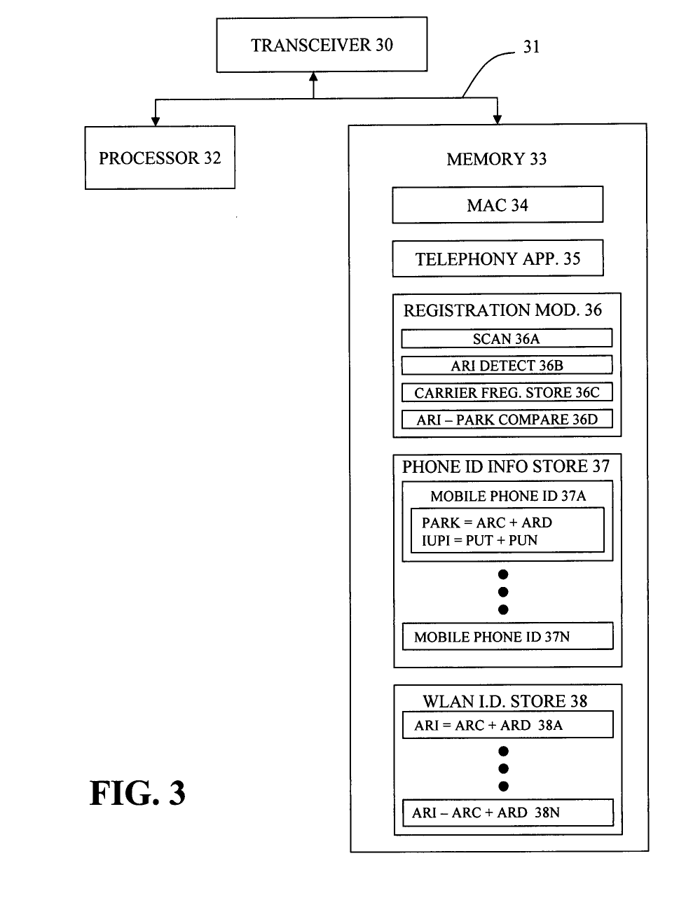

Continuing to refer to FIG. 1, it is often convenient to transport a portable part, such as mobile phone 3 configured to operate in the presence of one WLAN, WLAN 1a for instance, located in Europe to a WLAN 2a operating in another geographic region, such as the United States. In this case, and without employing the method of my invention, the mobile phone 3 when powered on after being transported from the environment of WLAN 2a to WLAN 1a is not able to initiate a communication session as it is not configured to operate in the frequency range of the local wireless network. Other than transporting multiple mobile phones each of which operates in different frequency bands, in order for the mobile phone to be operational, it is typically necessary for a site administrator to reconfigure the mobile phone, which may include some sort of re-programming of the mobile phones memory such that the phone is able to transmit and receive information in the frequency range that the local WLAN is operating in. As the result of the need to reprogram the mobile phone, the phone is not available to be used for some period of time, which tends to mitigate the convenience of transporting a mobile phone from site to site. However, employing the preferred embodiment of my invention, which is described in detail with reference to FIG. 3, it is possible to transport a single mobile phone between geographic regions without the need to reprogram the phone.

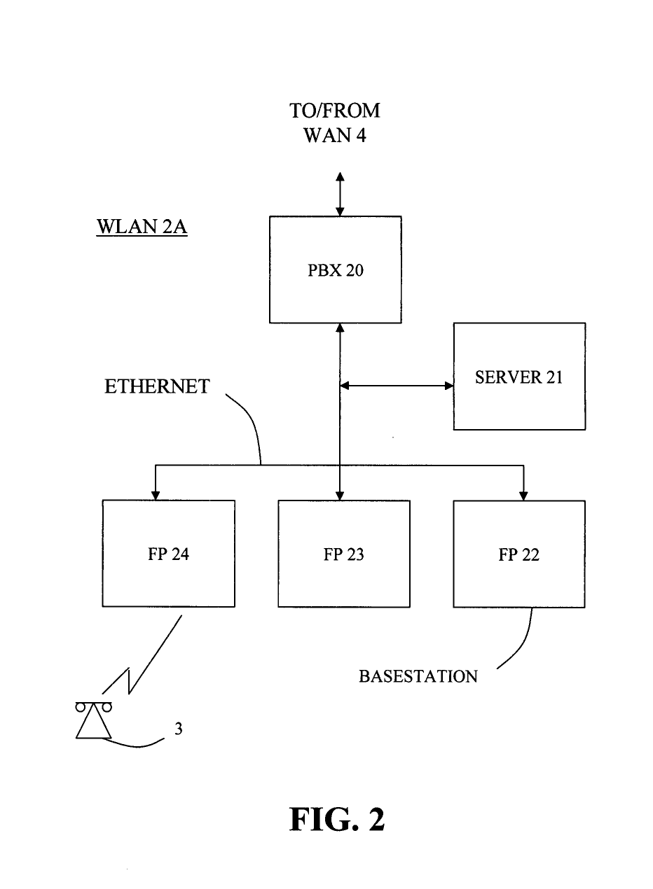

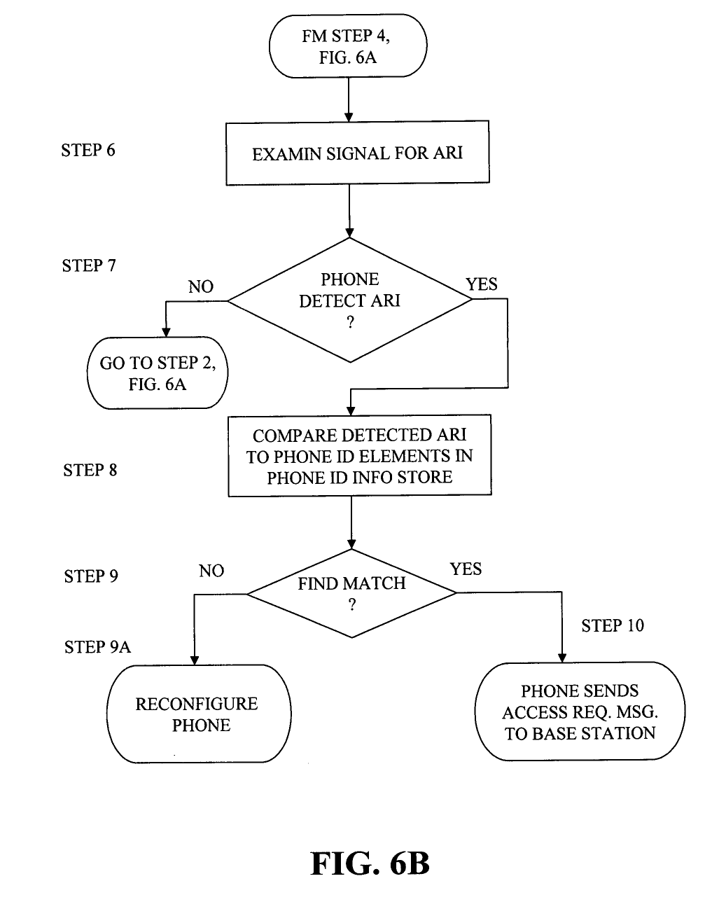

FIG. 2 is a block diagram showing the component parts of a generic WLAN such as either of the two WLAN 1a or 2a shown in FIG. 1. For the purposes of this description, we will designate this WLAN to be WLAN 2a, but it should be understood that it could be any one of the WLANs. WLAN 2a includes a PBX 20 (IP-PBX or PBX) which functions as the interface between the WAN environment (Internet or PSTN) and the WLAN environment, a server or switch 21 which generally functions as a control interface between the WLAN 2a and the PBX 20. For instance, the server receives packets of information from the PBX and transmits them to the proper stationary communication device which in the DECT standard is referred to as a fixed point (FP) which in this case could be any one of stationary communication devices 22, 23 or 24. The WLAN 2a also receives packets of information from any of the stationary communication devices and transmits them to the PBX if their destination address is not internal to the WLAN 2a, or transmits the packets to one of the other stationary communication devices, for instance, if the packet is addressed to a communications device located on the WLAN 2a. The stationary communication devices 22, 23 and 24, each of which I will refer to subsequently as a base station, generally function to convert packets of information from a wired signal format to a wireless signal format, or vise versa, and to control the access that wireless communication devices such as mobile phones have to the WLAN 2a. Each of the base stations provides wireless communication services to a number of mobile phones, such as mobile phone 3. In this case, and in the preferred embodiment of my invention, mobile phone 3 is designed to operate according to the DECT standard and is automatically adaptable to a WLAN frequency environment different from the frequency environment it last operated in. So for instance, if the mobile phone 3 is originally configured to operate in the frequency environment of WLAN 2a and it is subsequently transported to the frequency environment of WLAN 1a, the mobile phone, when powered on, will automatically reconfigure itself to operate in the new environment. The automatic process by which this reconfiguration takes place will be described later with reference to FIG. 6.

FIG. 3 is a high-level, functional block diagram of the mobile phone 3 showing those functional elements necessary for the operation of the preferred embodiment of my invention. The mobile phone includes a transceiver 30 which functions to demodulate wireless signals containing voice information received by the phone from a base station or to modulate signals for transmission to a base station. The transceiver 30 can be programmed or selected to operate at any of the possible WLAN frequencies, such as the four DECT frequencies previously mentioned. The programming or selection is preferably done electronically using signals inside the mobile phone 3 and not requiring external connections. The transceiver is connected by a bus 31 to a processor 32 and to a memory 33. The processor 32 generally functions in conjunction with the memory 33, and under the control of a main or telephony application 35 stored in the memory to perform certain functions necessary for the operation of the mobile phone. The telephony application 35 generally controls such functionality as initiating, maintaining and ending a communications session. Memory 33 also is used to store a medium access control (MAC) module 34 that generally provides service to control the mobile phone 3 access to the wireless medium as well as specifying the logical channels that are used. The MAC module functions logically as an interface between the telephony application 35 and a physically layer that in the case of the mobile phone is represented by certain aspects of the transceiver 30 operation. Further, the Memory also includes a registration module 36 that can be either automatically invoked by the telephony application 35 whenever the mobile phone is powered on and is not able to sense any signals or manually selected when the mobile phone has been transported into a new WLAN environment. The registration module is comprised of a frequency scanning function 36a, an Access Rights Information (ARI) detection function 36b and a carrier frequency store 36c. Generally, and according to the preferred embodiment of my invention, registration module 36 operates to find a frequency on which the local wireless LAN is operating and is initialized by the telephony application 35 in the event that the mobile phone is powered on and not able to detect any signals over the wireless medium. The registration module 36 initializes a frequency scanning function 36a that programs the transceiver 30 to sequentially scan through all of the frequency bands allocated to devices operating according to the DECT standard. More specifically, memory 33 can store some or all of the carrier frequencies or channels, over which to establish communication sessions with DECT devices, in a carrier frequency store 36c. The frequency scanning function 36a operates to sequentially sense the medium, in this case, for 17 milliseconds on each stored carrier frequency or channel looking for a signal. If a signal is received on any particular carrier frequency, the scanning process stops at that frequency, the signal is temporarily stored in memory for examination by an ARI detection routine 36b to determine whether it contains access rights information. This scanning and ARI detection process will be described in more detail later with reference to FIG. 6.

Continuing to refer to FIG. 3, the memory 33 is also employed to store one or more mobile phone identification information elements shown as 37a to 37n in a mobile phone identity information element store 37. Each of the mobile phone identification information elements include a Portable Part Access Rights Key (PARK) and an International Portable User Identify (IPUI) collectively labeled 37a. The PARK is composed an Access Rights Class (ARC) portion which shows the type of access to a DECT network and Access Rights Detail (ARD) portion which is a number unique to a service provider or to the mobile phone. The IPUI contains information that uniquely defines one user within the domain defined by his access rights related to this IPUI. The memory is also employed to store one or more WLAN identification information elements 38a to 38n each one of which is composed of an Access Rights Identity (ARI) and all of which are maintained in a WLAN identification information element store 38. The store 38, with the one or more WLAN identification information elements, can be preconfigured into the mobile phone by a network administrator. The structure of each ARI is the same as that for the PARK and is composed of an Access Rights Class (ARC) portion and an Access Rights Details (ARD) portion. The ARC contains information that is indicative of the type of access available to a DECT network, such as public, residential or private. The ARD contains a number which is unique to the service provider or the organization maintaining the DECT network.

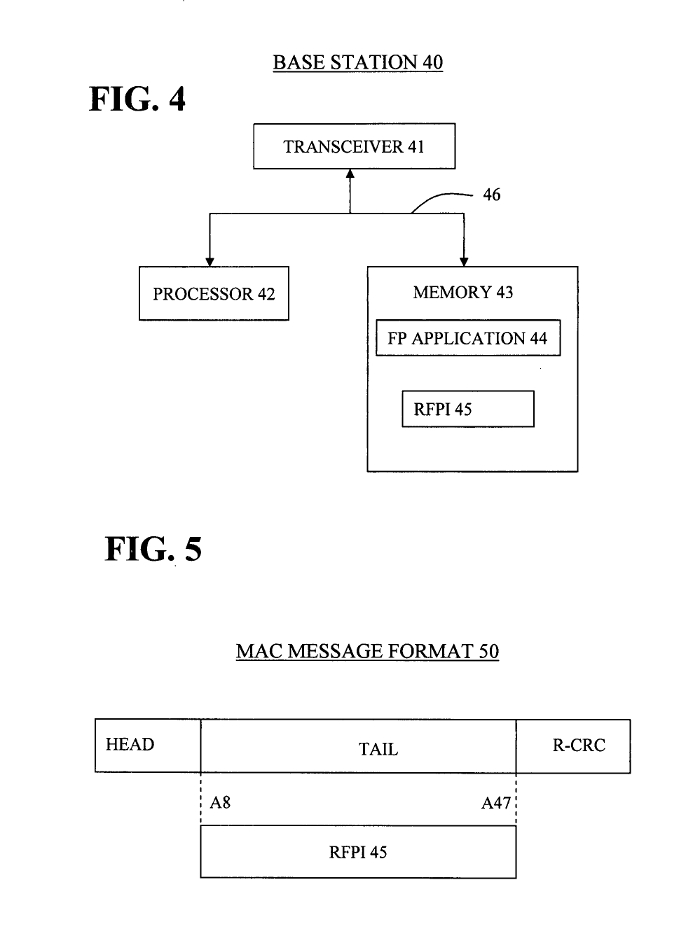

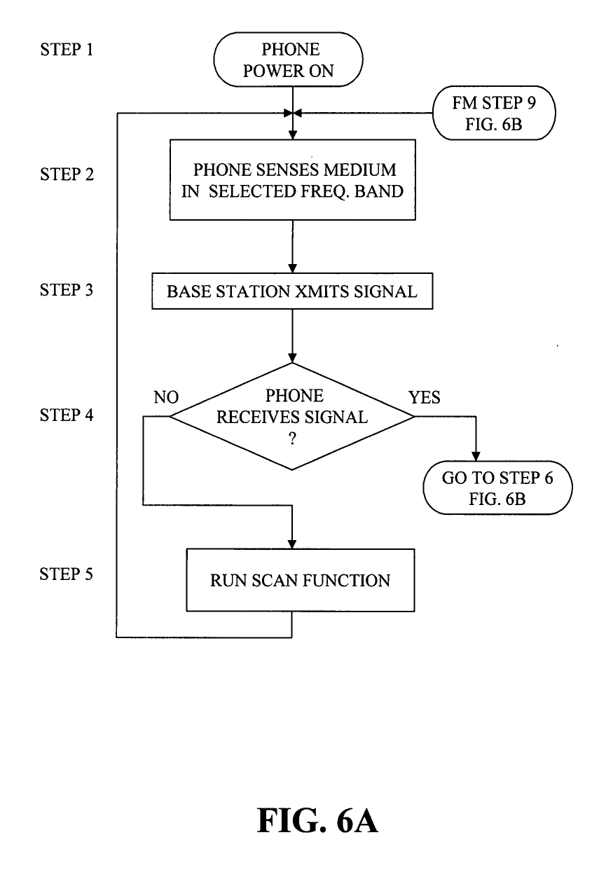

Referring now to FIG. 4, which is a high level functional block diagram of a fixed part (F.P.) or stationary communication device located in the wireless LAN. This stationary device can be a base station, an access point or any other communication device that transmits signals over the air to wireless communication devices and receives signals over the air from wireless communication devices. I will refer to this stationary communication device as base station 40. The base station includes a transceiver 41 that performs much of the same functionality as the transceiver in the mobile phone, a processor 42 and memory 43 in which is stored, among other things, a main application 44 and an RFPI 45 which is composed of an ARI and a radio fixed part (FP) number. The RFPI is transmitted periodically by the base station and functions to carry the ARI information, to uniquely identify a base station, and to show domains for handover and location information. FIG. 5 is an illustration showing the general format of a DECT MAC message 50 with the RFPI 45 included in one field. Generally, a MAC message is composed of an eight bit header field, a 40 bit tail field and some number of bits in an R-CRC field. As previously described with reference to FIG. 4, a message including RFPI information such as that included in RFPI 45 is transmitted periodically by the base station on a particular carrier frequency. When mobile phone 3 is powered on and, after scanning the medium for some specified period of time, receives a message that contains the RFPI information, it uses this information to determine whether or not it is configured so as to be able to transmit an access request message to the base station_on the network. This access request message includes a Fixed Part MAC Identity (FMID) which is derived from the RFPI 45, of instance, and a Portable Part MAC Identify (PMID) which can be a default value, an assigned value or an emergency value. The base station 40 uses the information contained in the PMID in order to start and maintain a communications session. I will not describe in detail the general operation of the base station and its functional elements as this is not important to the understanding of my invention and is generally well understood by practitioners in the field of wireless communications technology.

FIG. 6a is a high level logical flow diagram of the automatic registration process of my invention. It should be assumed, for the purpose of this description, that mobile phone 3 is transported from a first WLAN, WLAN 1a for instance, that operates in a first frequency band to a second WLAN, WLAN 2a for instance, that operates in a second frequency band and that the mobile phone is initially registered/configured to operate on the first WLAN. In step 1, the mobile phone is powered on within communication range of the second WLAN and in step 2 immediately starts to sense the medium for a signal at a frequency selected by the telephony application 35 of FIG. 3. This selected frequency would typically be the same frequency that the phone was using when it registered to access the first WLAN. In step 3, a base station, which could be FP 24 in FIG. 2 for instance, transmits a signal over the wireless medium. This signal can contain network management type information, it can contain session setup information or it can contain voice information. Regardless of the type if information contained in the signal, in step 4, if the mobile phone receives a message from the base station operating in the second WLAN, the process proceeds to step 6 in FIG. 6b, otherwise the process proceeds to step 5. In step 5, the telephony application 35 described with reference to FIG. 3 calls the registration module 36 which in turn can automatically initialize the scan function 36a. The scan function commences to examine the carrier frequency store 36c for a pointer to an initial carrier frequency, or selected frequency that it can use to sense the wireless medium for a signal. This selected carrier frequency value is then used by the telephony application to control the frequency at which the mobile phone operates to transmit and receive signals, and the pointer is incremented to the next frequency in the frequency store. At this point, the process returns to step 2, and the mobile phone starts sensing the medium on the selected frequency. In the preferred embodiment of my invention, the process performs the step 2 to step 5 loop twice at each frequency stored in the carrier frequency store 36c of FIG. 3, but alternatively, the mobile phone can scan the wireless medium on each frequency only one time or more than one time looking for a signal without affecting the operation of my invention. In step 3, the base station transmits a signal and if in step 4 the phone receives the signal transmitted by the base station, the signal is temporarily stored in memory and the process proceeds to step 6 in FIG. 6b.

Referring now to FIG. 6b in step 6 of the process, the ARI detection function 36b examines the message temporarily stored in step 4 to determine if it contains an ARI. If in step 7, the ARI detection function detects an ARI in the message, it stores the ARI in memory and the process proceeds to step 8. On the other hand, it no ARI is detected in the message the process returns to step 2 in FIG. 6a and the mobile phone continues to sense the medium on the same frequency as before. In step 8, the registration module 36 employs the ARI-PARK comparison function 36d to compare the ARI stored in step 7 to the one or more mobile phone identities 37a to 37n stored in the mobile phone identify information element store 37. Specifically, the ARC and the ARD information contained in the ARI stored in step 7 is compared to the ARC and the ARD information contained in the PARKs which are contained in the one or more mobile phone identify elements 37a to 37n. If in step 9 this comparison process results in a match, that is the ARC and ARD information contained in the stored ARI and the ARC and ARD information contained in any one of the mobile phone identify information elements match, then the mobile phone determines that it can gain access to the WLAN, which in this case is WLAN 2a, and proceeds to step 10. Otherwise, in the event that no match is detected in step 9, the process can be halted and the mobile phone turned over to a network administrator for re-configuration. In step 10, the mobile phone 3 of FIG. 2 initiates a communication session with base station 24 by transmitting an access request message to the base station and if the base station can accept the traffic, a communications session starts.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method of operating a wireless communication device in the presence of a wireless LAN to configure the wireless device to operate in the frequency band of the wireless LAN, the method comprising:
upon powering on, the wireless communications device configuring itself for operation on a selected first frequency of a set of frequencies, the set of frequencies including those frequencies at which the wireless LAN may operate;
the wireless communications device monitoring for signals from a stationary communication device in the wireless LAN;
if no signal is received within a predetermined interval, the wireless communications device selecting a next frequency of the set of frequencies and configuring itself for operation on the next frequency and repeating the monitoring step;
if a signal is received within the predetermined interval, the wireless communications device receiving the signal transmitted by the stationary communication device on the selected frequency and detecting in the signal wireless LAN identification information associated with the wireless LAN;
the wireless communications device comparing the detected wireless LAN identification information associated with the wireless LAN with wireless communication device identity information stored in the wireless communications device memory; and
if there is a match between the detected wireless LAN identification information and the stored wireless communication device identity information, the wireless communications device transmitting a signal to the stationary communication device containing unique device identification information using the selected frequency.

2. The method of claim 1 further comprising:
if a signal is received within the predetermined interval and the wireless communications device does not detect wireless LAN identification information in the signal the wireless communications device selecting a next frequency of the set of frequencies and configuring itself for operation on the next frequency and repeating the monitoring step.

3. The method of claim 1, wherein the wireless communication device is one of a mobile phone, a PDA and a portable, wireless computer.

4. The method of claim 1, wherein the configuring for operation on the first frequency is automatically started by the wireless communication device upon powering on.

5. The method of claim 1, wherein the configuring for operation on the first frequency is manually started upon powering on the wireless communication device.

6. The method of claim 1, wherein the stationary communication device is one of a base station and an access point.

7. The method of claim 1, wherein the selected first frequency is the frequency on which the wireless communication device was operating during a last communication session.

8. The method of claim 1, wherein the wireless LAN identification information is comprised of access rights information.

9. The method of claim 8, wherein the access rights information is comprised of an access rights class and access rights details.

10. The method of claim 1, wherein the wireless communication device identification information is comprised of a portable access rights key and an international portable user identify.

11. A wireless communication device for operation in the presence of a wireless LAN which automatically configures itself to operate in the frequency band of the wireless LAN, the wireless LAN including a stationary communication device, the wireless communication device comprising:
a programmable transceiver;
a processor coupled to the programmable transceiver; and
a memory coupled to the processor, the memory including:
a first location for temporarily storing a message received from the stationary communication device;
a second location storing a set of frequencies including those frequencies at which the wireless LAN may operate;
a third location storing wireless communication device identity information; and
programs for execution on the processor which cause the processor to perform the following steps:
configuring the wireless communications device for operation on a selected first frequency of the set of frequencies;
monitoring for signals from the stationary communication device in the wireless LAN;
if no signals are received within a predetermined interval, selecting a next frequency of the set of frequencies and configuring the wireless communications device for operation on the next frequency band and repeating the monitoring step;
if signals are received within the predetermined interval, receiving a message transmitted by the stationary communication device on the selected frequency and detecting in the message the wireless LAN identification information associated with the wireless LAN;
comparing the detected wireless LAN identification information associated with the wireless LAN with the stored wireless communication device identity information; and
if there is a match between the detected wireless LAN identification information and the stored wireless communication device identity information, transmitting a message to the stationary communication device containing unique device identification information using the selected frequency.

12. The wireless communication device of claim 11, the programs for execution on the processor which cause the processor to perform steps further comprising:
if a signal is received within the predetermined interval and the wireless communications device does not detect wireless LAN identification information in the signal, selecting a next frequency of the set of frequencies and configuring itself for operation on the next frequency and repeating the monitoring step.

13. The wireless communication device of claim 11, wherein the wireless communication device is one of a mobile phone, a PDA and a mobile computer.

14. The stationary communication device of claim 11, wherein the stationary communication device is one of a base station and an access point.

15. The wireless communication device of claim 11, wherein the wireless LAN identification information is comprised of access rights information.

16. A method of operating a wireless LAN, the wireless LAN operating at a frequency, the method comprising:
upon powering on, a wireless communications device configuring itself for operation on a selected first frequency of a set of frequencies, the set of frequencies including those frequencies at which the wireless LAN may operate;
a stationary communication device periodically transmitting a signal over the wireless medium, the signal including wireless LAN identification information;
the wireless communications device monitoring for signals from the stationary communication device in the wireless LAN;
if no signals are received within a predetermined interval, the wireless communications device selecting a next frequency of the set of frequencies and configuring itself for operation on the next frequency and repeating the monitoring step;
if signals are received within the predetermined interval, the wireless communications device receiving a message transmitted by the stationary communication device on the selected frequency and detecting in the message the wireless LAN identification information associated with the wireless LAN;
the wireless communications device comparing the detected wireless LAN identification information associated with the wireless LAN with wireless communication device identity information stored in the wireless communications device memory; and
if there is a match between the detected wireless LAN identification information and the stored wireless communication device identity information, the wireless communications device transmitting a message to the stationary communication device containing unique device identification information using the selected frequency band.

17. The method of claim 16 further comprising:
if signals are received within the predetermined interval and the wireless communications device does not detect wireless LAN identification information in the signal, the wireless communications device selecting a next frequency of the set of frequencies and configuring itself for operation on the next frequency and repeating the monitoring step.

18. The method of claim 16, wherein the wireless communication device is one of a mobile phone, a PDA and a portable, wireless computer.

19. The method of claim 16, wherein the configuring the wireless communication device for operation on the first frequency is automatically started by the wireless communication device upon powering on.

20. The method of claim 16, wherein the configuring the wireless communication device for operation on the first frequency is manually started upon powering on the wireless communication device.

21. The method of claim 16, wherein the stationary communication device is one of a base station and an access point.

22. The method of claim 16, wherein the selected first frequency is the frequency on which the wireless communication device was operating during a last communication session.

23. The method of claim 16, wherein the wireless LAN identification information is comprised of access rights information.

24. The method of claim 23, wherein the access rights information is comprised of an access rights class and access rights details.

25. The method of claim 16, wherein the wireless communication device identification information is comprised of a portable access rights key and an international portable user identify.
